(19) United States
(12) Patent Application Publication
(10) Pub. No.: US 2026/0063566 A1
(43) Pub. Date: Mar. 5, 2026

(54) INSPECTION APPARATUS AND INSPECTION SYSTEM

(71) Applicant: CANON KABUSHIKI KAISHA, Tokyo (JP)

(72) Inventor: MASAAKI MURAISHI, Chiba (JP)

(21) Appl. No.: 19/313,615

(22) Filed: Aug. 28, 2025

(30) Foreign Application Priority Data
Sep. 3, 2024 (JP) 2024-151533

(51) Int. Cl. G01N 21/88

(52) U.S. Cl. CPC G01N 21/8851; G01N 2021/8864; G01N 2021/888; G01N 2021/8893

(57) ABSTRACT

An inspection system includes a reading unit configured to acquire a scanned image by reading a recording medium on which an image is formed, and one or more controllers having one or more processors and one or more memories, the one or more controllers being configured to register a reference image, perform an inspection on the scanned image by comparing the scanned image with the reference image, set an inspection area to be inspected in the inspection, and delete a part of the inspection area.

### BACKGROUND

### Field of the Technology

The present disclosure relates to an inspection apparatus and an inspection system.

### Description of the Related Art

Conventionally, inspections to check whether a printed matter is accurately printed have been conducted manually. In recent years, apparatuses that automatically conduct the inspections as post-processing of a printing machine have been used. In such an inspection apparatus, correct image data is registered in advance. Then, an image forming apparatus prints out input image data on a sheet, and a sensor located inside the inspection apparatus reads the image printed out on the sheet. The inspection apparatus compares the image data read by the sensor with the correct image data that is registered in advance, thereby detecting an abnormality in a printed matter. An inspection for detecting an abnormality in an image portion of a printed matter is hereinafter referred to as a print image inspection.

In the print image inspection, the required quality varies depending on a business form and a printed matter of a user, and thus it is important to conduct an inspection necessary and sufficient for an inspection requirement. If an inspection criterion is too loose, printed matters having defects may be shipped. However, if the inspection criterion is too strict, a printed matter that does not originally need to be regarded as defective may be regarded as defective, so that the number of discarded sheets can increase, or the user needs to visually check again whether there is a defect among the defective printed matters.

To address such an issue, Japanese Patent Application Laid-Open No. 2011-158421 discusses a method for conducting a print image inspection on a plurality of inspection areas arranged on a printed matter.

### SUMMARY

According to embodiments of the present disclosure, an inspection system includes a reading unit configured to acquire a scanned image by reading a recording medium on which an image is formed, and one or more controllers having one or more processors and one or more memories, the one or more controllers being configured to register a reference image, perform an inspection on the scanned image by comparing the scanned image with the reference image, set an inspection area to be inspected in the inspection, and delete a part of the inspection area.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a configuration of an inspection system including an inspection apparatus according to a first exemplary embodiment.

FIG. 2 is a block diagram illustrating an example of an internal configuration of an image forming apparatus according to the first exemplary embodiment.

FIG. 3 is a block diagram illustrating an example of an internal configuration of the inspection apparatus according to the first exemplary embodiment.

FIG. 4 is an example of a flowchart illustrating overall inspection processing according to the first exemplary embodiment.

FIG. 5 illustrates an example of a job management user interface (UI) screen according to the first exemplary embodiment.

FIG. 6 illustrates an example of an inspection settings UI screen according to the first exemplary embodiment.

FIG. 7 is an example of a flowchart illustrating inspection settings in step S403 according to the first exemplary embodiment.

FIGS. 8A, 8B, 8C, 8D, and 8E each illustrate an example of partial inspection area deletion according to the first exemplary embodiment.

FIGS. 9A, 9B, and 9C each illustrate an example of partial inspection area deletion according to the first exemplary embodiment.

FIGS. 10A and 10B each illustrate an example of an inspection area setting according to the first exemplary embodiment.

FIG. 11 is an example of a flowchart illustrating inspection settings in step S403 according to a second exemplary embodiment.

FIGS. 12A, 12B, and 12C each illustrate an example of partial inspection area deletion according to the second exemplary embodiment.

### DESCRIPTION OF THE EMBODIMENTS

Exemplary embodiments of the present disclosure will be described in detail with reference to the accompanying drawings. The following exemplary embodiments are not intended to limit the disclosure according to the scope of the claims, and not all combinations of features described in each exemplary embodiment are necessarily essential to the solution of the present disclosure. In the present exemplary embodiment, an image forming apparatus is described as an example of an information processing apparatus, but the present disclosure is not limited thereto.

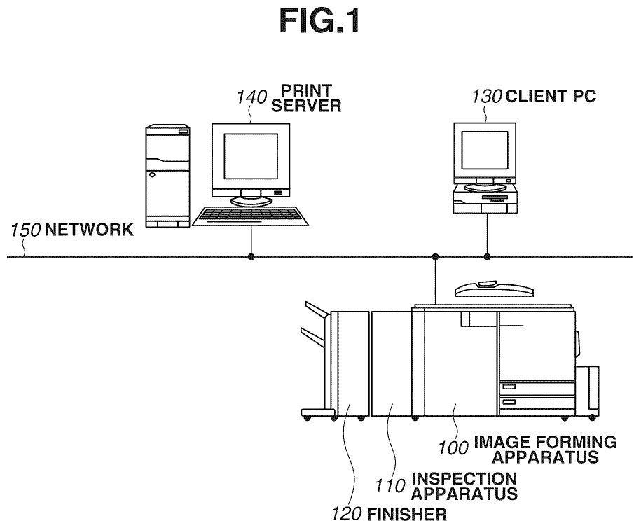

FIG. 1 is a diagram illustrating a configuration of an inspection system including an inspection apparatus according to a first exemplary embodiment of the present disclosure. The configuration of the inspection system includes an image forming apparatus 100, an inspection apparatus 110, a finisher 120, a client personal computer (PC) 130, a print server 140, and a network 150.

The image forming apparatus 100 performs printing based on various kinds of input data such as print data transmitted from the client PC 130 or the print server 140.

While, in the first exemplary embodiment, an image forming apparatus is described, the present disclosure is not limited thereto. Any apparatus that performs printing on a recording medium may be used. For example, an apparatus that performs printing on metal may be used.

The inspection apparatus 110 receives a printed matter output from the image forming apparatus 100, and conducts an inspection to check whether the received printed matter has a defect. Here, the defect is a deterioration in the quality of the printed matter. Examples of the defect include stain caused by a color material adhering to an unintended area during printing, and color omission resulting from insufficient deposition of a color material on an intended area.

Further, in variable printing including a variable area portion such as a character string or a barcode, the inspection apparatus 110 conducts an inspection on the variable area portion. For example, the inspection apparatus 110 conducts a data readability inspection to check whether a character string or a barcode is readable, and also conducts a data cross-check inspection to compare a read result of the character string or the barcode with correct reference data. In other words, the inspection apparatus 110 conducts a print image inspection to detect an abnormality in an image portion of a printed matter, and data inspections including a data readability inspection and a data cross-check inspection. The inspection apparatus 110 need not necessarily be equipped with an inspection processing unit configured to conduct the print image inspection and data inspections. For example, a configuration in which inspection processing is performed on an inspection PC (not illustrated) that is communicatively connected to the inspection apparatus 110 may be employed.

The finisher 120 receives an output sheet inspected by the inspection apparatus 110, switches a sheet discharge destination based on an inspection result of the inspection apparatus 110, executes post-processing (e.g., bookbinding and stapling) as needed, and discharges the sheet.

The image forming apparatus 100 is connected to the client PC 130 and the print server 140 via the network 150, and is also connected to the inspection apparatus 110 and the finisher 120 via a communication cable. The inspection apparatus 110 is connected to the image forming apparatus 100 and further to the finisher 120 via the communication cable. The first exemplary embodiment will be described using, as an example, an in-line inspection machine that seamlessly performs image formation, inspection, post-processing, and sheet discharge. However, this example is not intended to limit the present disclosure.

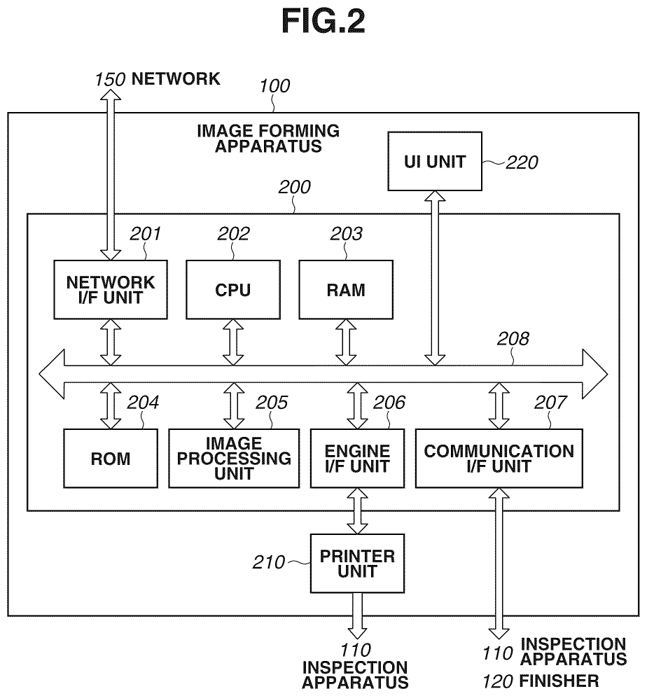

FIG. 2 is a block diagram illustrating an internal configuration of the image forming apparatus 100 according to the first exemplary embodiment.

A controller 200 receives images and documents from the network 150 and converts the received images and documents into print data. A printer unit 210 generates a printed matter obtained by printing print data on a recording sheet (paper, sheet). A user interface (UI) unit 220 displays a screen and receives an instruction such as selection of sheet information for the image forming apparatus 100 from a user. The image forming apparatus 100 includes the controller 200, the printer unit 210, and the UI unit 220 described above.

The controller 200 includes a network interface (I/F) unit 201, a central processing unit (CPU) 202, a random access memory (RAM) 203, a read-only memory (ROM) 204, an image processing unit 205, an engine I/F unit 206, a communication I/F unit 207, and an internal bus 208.

The network I/F unit 201 transmits and receives data to and from the client PC 130 and the print server 140 via the network 150. The CPU 202 controls the entire image forming apparatus 100.

The RAM 203 is a work area used by the CPU 202 to execute various instructions. The ROM 204 stores program data to be executed by the CPU 202 at the time of activation, configuration data for the controller 200, and the like.

The image processing unit 205 performs raster image processor (RIP) processing for converting image data and document data received from the network 150 into print data. In the first exemplary embodiment, RIP processing need not necessarily be performed by the image processing unit 205, but instead may be performed by, for example, an information processing apparatus (not illustrated) that is communicably connected to the image forming apparatus 100.

The engine I/F unit 206 transmits print data to the printer unit 210. The communication I/F unit 207 communicates with the inspection apparatus 110 and the finisher 120. The internal bus 208 is a communication path.

Images and documents created on the client PC 130 or the print server 140 on the network 150 are transmitted as page description language (PDL) data to the image forming apparatus 100 via a network (e.g., a local area network). A configuration may be employed in which a print job of an image, a document, or the like is transmitted to an information processing apparatus (not illustrated) via a network and is managed by the information processing apparatus. A configuration may also be employed in which a print job is transmitted from the information processing apparatus to the image forming apparatus 100 via the network 150 and the image forming apparatus 100 performs printing processing on a sheet.

The transmitted PDL data is stored in the RAM 203 via the network I/F unit 201. The RAM 203 also stores a print instruction from the user issued on the UI unit 220 via the internal bus 208. Examples of the print instruction from the user include selection of a sheet type.

The image processing unit 205 acquires PDL data stored in the RAM 203 and performs image processing for converting the PDL data into print data. The image processing for converting the PDL data into print data is, for example, processing of rasterizing the PDL data, converting the PDL data into multi-valued bitmap data, and performing screen processing or the like thereon to thereby convert the PDL data into binary bitmap data. The binary bitmap data obtained by the image processing unit 205 is transmitted to the printer unit 210 via the engine I/F unit 206.

The printer unit 210 prints the received binary bitmap data on a recording sheet with a color material. The CPU 202 issues an instruction to the printer unit 210 based on the print instruction from the user, which is stored in the RAM 203. For example, when receiving an instruction from the user to print on coated paper, the CPU 202 issues an instruction to cause the printer unit 210 to output a sheet from a sheet cassette (not illustrated) in which coated paper is stored in the image forming apparatus 100. Various processes from reception of PDL data described above to printing on a sheet are controlled by the CPU 202 to thereby form a full-color toner image on the sheet.

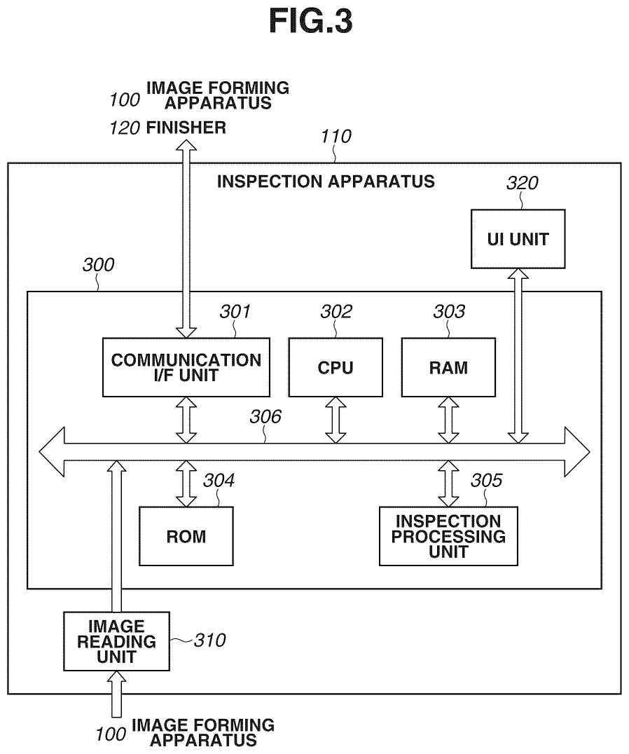

FIG. 3 is a block diagram illustrating an internal configuration of the inspection apparatus 110.

An inspection control unit 300 controls the entire inspection apparatus 110 and inspection processing to check whether each printed matter has a defect.

An image reading unit 310 reads a printed matter conveyed from the image forming apparatus 100.

The image reading unit 310 reads the printed matter to thereby generate a scanned image (read sheet).

A UI unit 320 is a UI unit for the user to perform settings for the inspection apparatus 110 and display an inspection result for the user. The settings for the inspection apparatus 110 performed by the user herein are inspection items specifying which types of defects are to be inspected during inspection of a printed matter. Examples of the inspection items include a circular defect (spot) and a linear defect (streak). The inspection apparatus 110 includes the inspection control unit 300, the image reading unit 310, and the UI unit 320 described above. In the first exemplary embodiment, the UI unit 320 includes a display unit for displaying a screen and a display control unit for controlling the screen to be displayed on the display unit. As for settings for the inspection apparatus 110, display of inspection results, and the like performed on the UI unit 320, the UI unit 220 of the image forming apparatus 100 described above or an external apparatus, such as the inspection PC (not illustrated) or the information processing apparatus (not illustrated), may be configured to receive the display and instructions.

The inspection control unit 300 includes a communication I/F unit 301, a CPU 302, a RAM 303, a ROM 304, an inspection processing unit 305, and an internal bus 306.

The communication I/F unit 301 transmits and receives data to and from the image forming apparatus 100, and the finisher 120. The CPU 302 controls the entire inspection apparatus 110. The RAM 303 is a work area used by the CPU 302 to execute various instructions. The ROM 304 stores program data to be executed by the CPU 302 at the time of activation, configuration data for the inspection control unit 300, and the like. The inspection processing unit 305 conducts an inspection to check whether each printed matter has a defect. The internal bus 306 is a communication path.

An outline of a print image inspection to be performed by the inspection apparatus 110 will be described. The inspection apparatus 110 causes the image reading unit 310 to read a printed matter conveyed from the image forming apparatus 100, and acquires a scanned image (read image) to be inspected. The acquired scanned image to be inspected is stored in the RAM 303. Subsequently, the inspection apparatus 110 causes the inspection processing unit 305 to acquire a difference value between the scanned image to be inspected and a reference image that is preliminarily stored as a correct image in the RAM 303.

Next, the inspection apparatus 110 conducts an inspection by comparing the calculated difference value with an inspection threshold (contrast, size, or the like) of each inspection item for each pixel. Inspection results are stored in the RAM 303. For example, information indicating whether there is an abnormality in each printed matter, the type (dot or streak) of each detected abnormality, positional information about the abnormality to be displayed on the UI unit 320, and the like are stored.

An outline of a data inspection to be performed by the inspection apparatus 110 will be described. The inspection apparatus 110 causes the image reading unit 310 to read a printed matter conveyed from the image forming apparatus 100, and acquires a scanned image to be inspected. The acquired scanned image to be inspected is stored in the RAM 303. Subsequently, the inspection apparatus 110 causes the inspection processing unit 305 to conduct an inspection to check whether character strings and barcodes are readable using preconfigured glyph fonts for optical character recognition (OCR) and barcode standards. When the character strings and barcodes are readable, the inspection is determined to be a pass, whereas when the character strings and barcodes are not readable, the inspection is determined to be a fail.

It is also possible to conduct a data cross-check inspection for comparing results of reading character strings and barcodes with the corresponding data (correct reference data) in a correct reference comma-separated values (CSV) file prepared in advance. Also, in this case, when pieces of data match as a result of the comparison, the inspection is determined to be a pass. When the pieces of data do not match, the inspection is determined to be a fail. Inspection results are stored in the RAM 303. For example, results of reading the character strings and barcodes from the printed matter, a result of comparison with the correct reference data, position information about the read character strings and barcodes to be displayed on the UI unit 320, and the like are stored.

Next, the inspection apparatus 110 causes the CPU 302 to instruct the UI unit 320 to display the inspection result stored in the RAM 303. The inspection result is displayed on the UI unit 320, and thus the user can recognize the inspection result.

In a case where a defective printed matter is generated, or defective printed matters are consecutively generated in a certain quantity, the inspection apparatus 110 causes the CPU 302 to transmit information about the above to the image forming apparatus 100 via the communication I/F unit 301.

The information indicating that a defective printed matter(s) is/are generated is received by the controller 200 via the communication I/F unit 207. When the controller 200 receives the above-described information, the CPU 202 instructs the printer unit 210 to stop printing. The image forming apparatus 100 stops the printing operation when the printer unit 210 is instructed to stop printing.

Further, the inspection apparatus 110 causes the CPU 302 to also transmit the information to the finisher 120 via the communication I/F unit 301 based on the inspection result stored in the RAM 303. The information transmitted to the finisher 120 is information indicating whether the printed matter has a defect.

The finisher 120 uses the received information to discharge non-defective printed matters to a normal discharge tray and discharge defective printed matters to another tray different from the normal discharge tray.

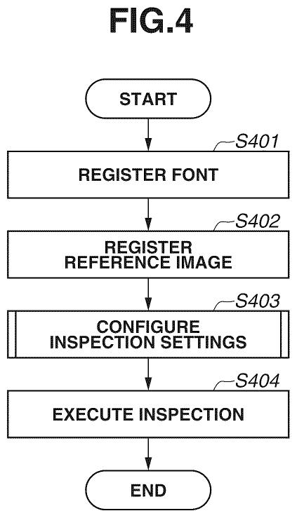

Next, a flow of overall processing from a registration operation before a start of an inspection to execution of the inspection in the inspection apparatus 110 will be described with reference to the flowchart illustrated in FIG. 4.

The processing in the flowchart is implemented by the CPU 302 loading a program code stored in the ROM 304 into the RAM 303 and reading out and executing the program code loaded into the RAM 303.

In step S401, the CPU 302 registers a glyph font. The glyph font registered herein is used for data inspection. A glyph font refers to data in which a character glyph image is associated with a character code to be used for OCR, which is performed during data inspections.

In a procedure for creating the glyph font, first, the inspection apparatus 110 waits in a glyph font image reading mode, and receives a print job for glyph font creation from the client PC 130. The inspection apparatus 110 receives a glyph font job from the client PC 130 and reads a glyph font image. When printing is executed, the inspection apparatus 110 detects conveyance of a printed matter from the image forming apparatus 100 and causes the image reading unit 310 to scan the printed matter, and then stores a scanned image in the RAM 303 of the inspection apparatus 110. The inspection apparatus 110 may create a glyph font by cutting out characters to be subjected to OCR one character at a time from the scanned image, and allowing the user to input character codes corresponding to cut-out character images. The inspection apparatus 110 stores the created glyph font in the RAM 303. While, in the first exemplary embodiment, a method for creating a glyph font is described, the method is not limited thereto. Any method may be employed as long as data that associates character codes with character images cut out from the scanned image can be created. It is also possible to conduct only the print image inspection without performing the data inspection. In this case, the processing proceeds to step S402 without performing step S401.

In step S402, the CPU 302 registers the reference image as an inspection correct image. The inspection apparatus 110 waits in a reference image reading mode, and the client PC 130 executes a print job for reference image registration. When printing is executed, the inspection apparatus 110 detects conveyance of a printed matter and causes the image reading unit 310 to scan the printed matter. The scanned image is stored as the reference image in the RAM 303 of the inspection apparatus 110.

While, in the first exemplary embodiment, the image reading unit 310 scans the reference image and thereby registers the reference image, a registration method is not limited thereto. For example, a method of registering an image subjected to RIP processing in the print server 140 or the image processing unit 205 of the image forming apparatus 100 as the reference image may be employed.

In step S403, the CPU 302 stores various inspection setting values, such as values indicating an inspection area and an inspection level, with regard to the reference image in the RAM 303 of the inspection apparatus 110 according to inspection settings configured by the user.

The processing in step S403 according to the first exemplary embodiment will be described in detail below.

In step S404, the CPU 302 receives a print job for inspection from the client PC 130, and the image reading unit 310 detects conveyance of a sheet and scans the sheet. The scanned image is stored in the RAM 303 of the inspection apparatus 110. Then, the CPU 302 performs a print image inspection on the scanned image obtained in the print job for inspection and the reference image registered in step S402 using the inspection setting values configured in step S403. Further, the CPU 302 performs a data inspection using the glyph font registered in step S401 and the inspection settings configured in step S403. Then, the processing in this flowchart ends.

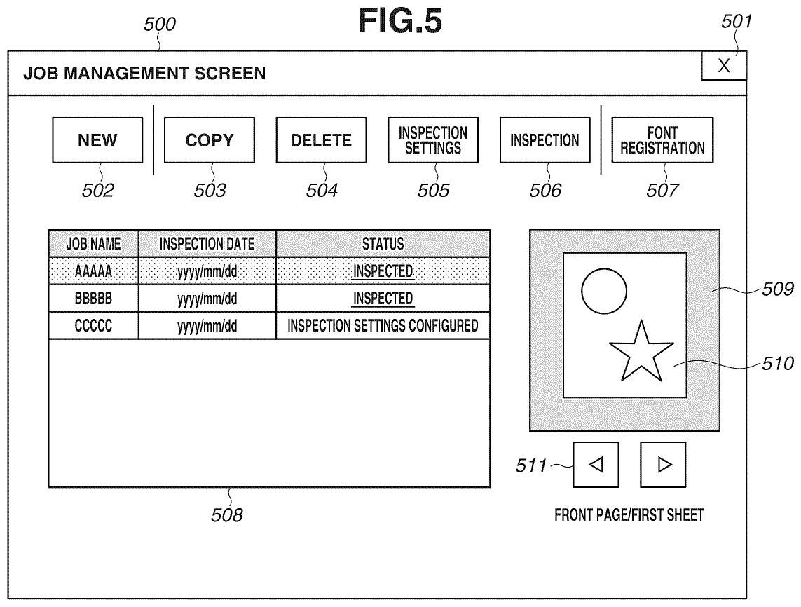

FIG. 5 illustrates an example of a job management screen 500 to be displayed on the UI unit 320.

The job management screen 500 is displayed at the time of activation of the inspection apparatus 110. Alternatively, the job management screen 500 is displayed at the time of activation of an application by a user operation through the UI unit 320.

The processing can proceed to processes of font registration, reference image registration, inspection settings, and inspection from the job management screen 500.

A button 501 is a button for closing the display of the job management screen 500. A button 502 is a button for creating a new inspection job and registering a reference image. A button 503 is a button for copying an already created inspection job. An inspection job selected from an inspection job list 508 is copied. The button 503 is a button for copying the reference image and inspection settings through copying, and making it possible to conduct a new inspection. When the button 503 is pressed, the selected inspection job is copied, and the inspection job is added to the inspection job list 508.

A button 504 is a delete button to delete the inspection job selected from the inspection job list 508. Here, a plurality of inspection jobs can be selected, and the plurality of inspection jobs can be deleted at once by pressing the button 504.

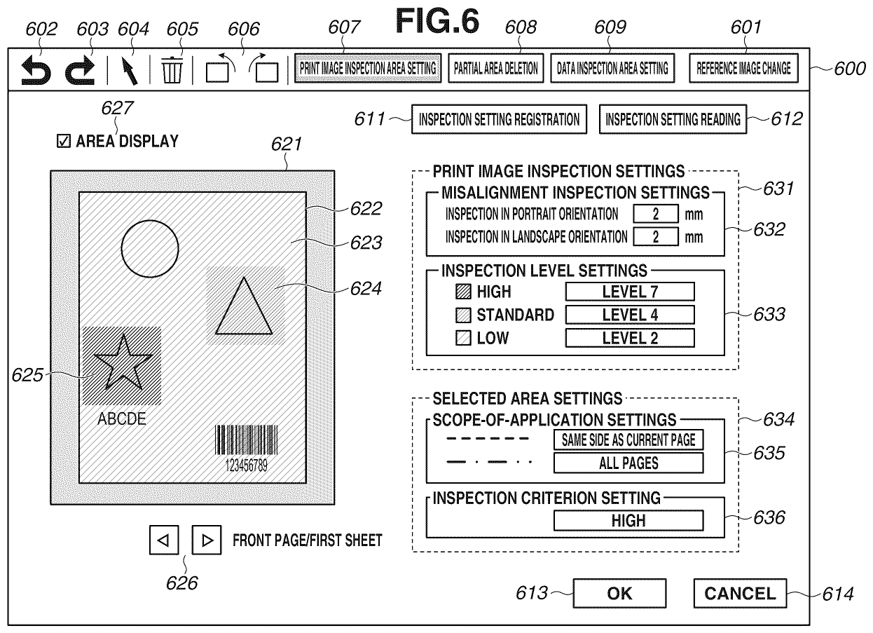

A button 505 is an inspection settings button for configuring inspection settings for the inspection job for which reference image registration has been completed. When the button 505 is pressed, the screen transitions to an inspection settings screen illustrated in FIG. 6. A button 506 is an inspection button for conducting an inspection on the inspection job for which the reference image registration and the inspection settings have been completed. A button 507 is a font registration button for registering a glyph font.

An area 509 is a display area for displaying a reference image 510 registered in the inspection job selected from the inspection job list 508. When there is a plurality of registered reference images, the image to be displayed is switched by using buttons 511. The front and back sides of the read sheet can be switched also by using the buttons 511. Although only the reference image is displayed herein, the inspection area may also be displayed.

Next, inspection settings will be described with reference to FIG. 6.

FIG. 6 illustrates an example of an inspection settings screen 600 to be displayed on the UI unit 320 of the inspection apparatus 110 to configure inspection settings.

A button 601 is a reference image change button for changing the reference image. A button 602 is a button for reverting an executed process by one step.

A button 603 is a button for redoing the process having been reverted by using the button 602. The target processes of the button 602 and the button 603 may be processes performed by all or part of operations on the inspection settings screen 600. A button 604 is an inspection area selection button to be pressed by the user when the user wants to select an already set area.

A button 605 is an inspection area delete button to be pressed by the user when the user wants to delete an already selected area. A button 606 is a button for rotating an image displayed in an area 621.

A button 607 is a button to be pressed by the user when the user creates a new print image inspection area. After the button 607 is pressed, the user sets an inspection area on a reference image 622 that is displayed in the area 621. Areas 623, 624, and 625 each indicates a setting example for the print image inspection area. The area 623 indicates an inspection area set with an inspection criterion “low”. The area 624 indicates an inspection area set with an inspection criterion “standard”. The area 625 indicates an inspection area set with an inspection criterion “high”. In a case where there is a plurality of registered reference images, the image to be displayed can be switched by using buttons 626. The buttons 626 can also be used to switch between the front and back sides of the read sheet. A setting item 627 is a setting item for switching between display and non-display of the inspection area.

A button 608 is a button to be pressed by the user when the user performs partial area deletion. After the button 608 is pressed, the user selects an area on the set inspection area, so that a part of the inspection area is deleted. This processing will be described in detail below.

A button 609 is a button to be pressed by the user when the user creates a new character inspection area or a new barcode inspection area. After the button 609 is pressed, the user sets the inspection area on the reference image 622 displayed in the area 621. A button 611 is a registration button for registering currently configured inspection settings. When the button 611 is pressed, the inspection settings are stored in the RAM 303. At the time of registration of the inspection settings, an inspection setting registration screen (not illustrated) may be opened so that an inspection setting name, a sheet size, the number of sheets, and the like can be specified and registered.

A button 612 is a button for reading the registered inspection settings and setting the inspection area on the reference image 622. When the button 612 is pressed, an inspection setting list screen (not illustrated) is opened. Then, the inspection settings selected on the inspection setting list screen are configured for the reference image 622. When the inspection settings are read, the read inspection settings may replace the inspection settings already configured for the reference image 622, or may be added.

A button 613 is an OK button to store the settings configured on the inspection settings screen 600 and transition to the job management screen 500 illustrated in FIG. 5. When the button 613 is pressed, the screen may transition to an inspection screen (not illustrated) so that an inspection can be executed. A button 614 is a cancel button to transition to the job management screen 500 illustrated in FIG. 5 without storing the settings configured on the inspection settings screen 600.

A setting area 631 is an area with a group of UIs used to configure print image inspection settings. A setting item 632 is misalignment inspection settings for setting a permissible deviation amount of a print position from the reference image.

In the first exemplary embodiment, a case is described where the user has specified to detect misalignment with a positional deviation amount of 2 mm or more. In other words, a value specified by the user in this case corresponds to a threshold for misalignment detection. In this case, if a deviation that is more than or equal to the set threshold is detected, the inspection is determined to be a fail.

A setting item 633 is a setting item for an inspection level of the print image inspection, and detection levels are set for inspection criteria “high”, “standard”, and “low”. The detection level is a parameter set in stages for each detected defect feature indicating from what size the feature is determined to be a defect. For example, nine levels from level 1 to level 9 are set, and level 9 enables detection of a thinner or smaller defect than level 1.

A setting area 634 is an area with a group of UIs used to configure advanced settings for a currently selected area in the reference image 622.

A setting item 635 is a setting item for the scope of application of a selected area. When nothing is selected in the setting item 635, the selected inspection area is located only on a page currently displayed in the area 621. When a “same side as current page” option is selected, the selected inspection area is located on a page on the same side depending on whether the selected inspection area is located on the front side or the back side of the sheet. When an “all pages” option is selected, the selected inspection area is located on all pages in the inspection job.

A setting item 636 is a setting item for an inspection criterion and is used to set the inspection criterion for the selected area. In this setting item, one of the inspection criteria “high”, “standard”, and “low” indicated in the setting item 633 is set.

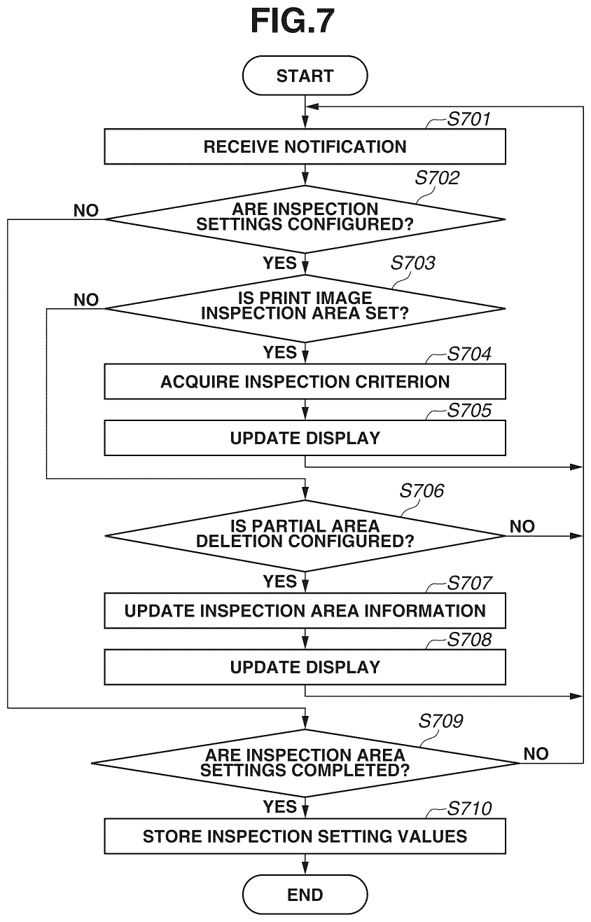

Next, a flow of the inspection settings in step S403 will be described with reference to a flowchart illustrated in FIG. 7.

Processing in this flowchart is implemented by the CPU 302 of the inspection apparatus 110 loading a program code stored in the ROM 304 into the RAM 303 and reading and executing the program code loaded into the RAM 303.

In step S701, the CPU 302 receives a notification of a UI operation performed by the user from the UI unit 320. In step S702, the CPU 302 determines whether inspection settings are configured.

Specifically, the CPU 302 determines whether a new inspection area is created, partial area deletion is configured, or inspection area settings already configured are changed. If inspection settings are configured (YES in step S702), the processing proceeds to step S703. If an operation other than the inspection settings is performed (NO in step S702), the processing proceeds to step S709.

In step S703, the CPU 302 determines whether a print image inspection area is set for the area for which the inspection settings are configured in step S702. If the print image inspection area is set (YES in step S703), the processing proceeds to step S704. If an area other than the print image inspection area is set (NO in step S703), the processing proceeds to step S706.

In step S704, the CPU 302 acquires an inspection criterion stored in the RAM 303. In step S705, the CPU 302 updates the display of the inspection area based on the inspection criterion acquired in step S705. For example, the color used in the display may be changed such that the inspection area set with the inspection criterion “high” is displayed in red, the inspection area set with the inspection criterion “standard” is displayed in blue, and the inspection area set with the inspection criterion “low” is displayed in green. Further, a density, transmittance, or pattern may be changed instead of the color. In the display of the inspection area, transmissive display is performed so that the reference image can be checked. However, the display of the inspection area is not limited thereto, and the inspection area may be displayed with a transmittance of 0%. Highlighting for identifying these inspection criteria may be used in combination.

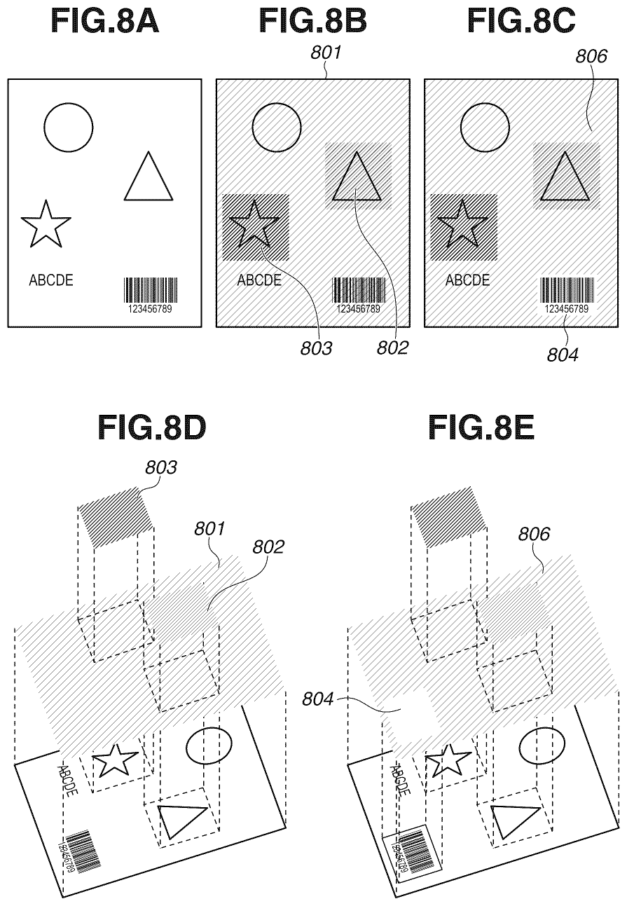

In step S706, the CPU 302 determines whether the partial area deletion is configured in step S702. If the CPU 302 determines that the partial area deletion is configured (YES in step S706), the processing proceeds to step S707. If the CPU 302 determines that the partial area deletion is not configured (NO in step S706), the processing returns to step S701 and waits for a notification of a UI operation. The partial area deletion will be described in detail with reference to FIGS. 8A to 8E.

In step S707, the CPU 302 updates information about the inspection area based on designation by the partial area deletion. For example, in a case where the CPU 302 holds the inspection area as image coordinate information, the print image inspection area excluding the area designated by the partial area deletion is divided into a plurality of areas, and the information about the inspection area is updated. The CPU 302 may hold the information about the inspection area not as the coordinate information but as layer data, and may update the information about the inspection area by deleting the area designated by the partial area deletion from the layer data on the inspection area. In step S708, the CPU 302 updates the display of the inspection area based on the information about the inspection area updated in step S707.

FIGS. 8A to 8E each illustrate an example of partial inspection area deletion. For example, in a case where one reference image is registered, inspection settings are configured, and an inspection is conducted on a plurality of copies, if a print image inspection is conducted on a variable portion on each page, such as in variable data, the image differs from the reference image, so that the inspection is determined to be a fail. For this reason, it may be desirable to delete the variable data portion from the inspection area. Accordingly, performing a partial inspection area deletion as illustrated in FIGS. 8A to 8E makes it possible to improve the inspection setting operability.

FIG. 8A illustrates a state where the inspection areas are hidden, and FIG. 8B illustrates a state where the inspection areas are displayed. FIG. 8B illustrates an inspection area 801 set with the inspection criterion “low”, an inspection area 802 set with the inspection criterion “standard”, and an inspection area 803 set with the inspection criterion “high”.

FIG. 8C illustrates an example where a part of the inspection area 801 illustrated in FIG. 8B is deleted. Variable data of a barcode is printed in a deleted portion 804. A part of the inspection area 801 is deleted from the inspection area 801 by designating the partial area deletion button 608, thereby an inspection area 806 is obtained.

FIG. 8D is a plane view of the area settings illustrated in FIG. 8B, and illustrates a layout example of the inspection area 801, the inspection area 802, and the inspection area 803. FIG. 8E illustrates a plane view of the area settings illustrated in FIG. 8C, and illustrates a case where a part of the inspection area 801 is deleted. Deletion of an inspection area corresponding to a variable data portion, such as a barcode, in this manner makes it possible to prevent occurrence of an inspection fail.

In the first exemplary embodiment, the inspection areas set with the inspection criteria “high”, “standard”, and “low” may overlap each other, and the inspection area set with the inspection criterion “high” may be processed with highest priority. Further, inspection settings may be held in an exclusive state such that the inspection areas set with different inspection criteria do not overlap each other. In a case where the entire inspection area is designated by the partial area deletion button 608, an operation of deleting the inspection area may be performed. In this case, the operation is similar to that when the inspection area is selected and the delete button 605 is pressed.

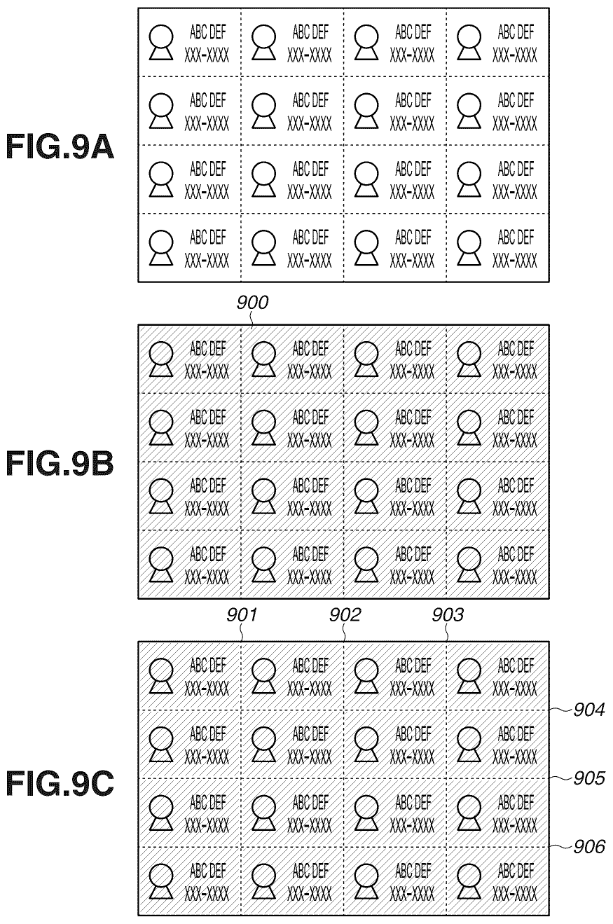

As another example, FIGS. 9A to 9C each illustrate an inspection setting example in a case where a sheet for 16 (4×4) name cards on which perforations are arranged in advance is used. For example, in the case of RIP inspection, an RIP image is used as the reference image, but the RIP image includes no information about perforations included in the sheet. On the other hand, an inspection image to be read during the inspection includes information about perforations included in the sheet. Accordingly, if a comparison inspection is conducted to compare the reference image including no information about perforations with the inspection image including information about perforations, perforation portions are detected and the inspection is determined to be a fail.

FIG. 9A illustrates a state where the inspection area is hidden. FIG. 9B illustrates a state where the inspection area is displayed. FIG. 9B illustrates a state where an inspection area 900 is set, and an area excluding sheet edges is set as the inspection area. In this case, the inspection area is set to include an area slightly inside of the sheet so as to prevent occurrence of inspection “fail” due to shade or the like of the sheet. FIG. 9C illustrates a state where a perforation portion 901, a perforation portion 902, a perforation portion 903, a perforation portion 904, a perforation portion 905, and a perforation portion 906 are deleted from the inspection area 900 illustrated in FIG. 9B. While it is generally necessary to create an inspection area 16 times by deleting a part of the inspection area from the inspection area, in present exemplary embodiment, the inspection area settings can be achieved by performing seven operations in total, i.e., performing one inspection area creation operation and performing six partial inspection area deletion operations. In the present exemplary embodiment, the reference image is displayed on a portion where no inspection area is located and on a portion where a part of the inspection area is deleted. However, the portion where no inspection area is located and the portion where a part of the inspection area is deleted may be displayed with different colors, different transmittances, different patterns, or the like.

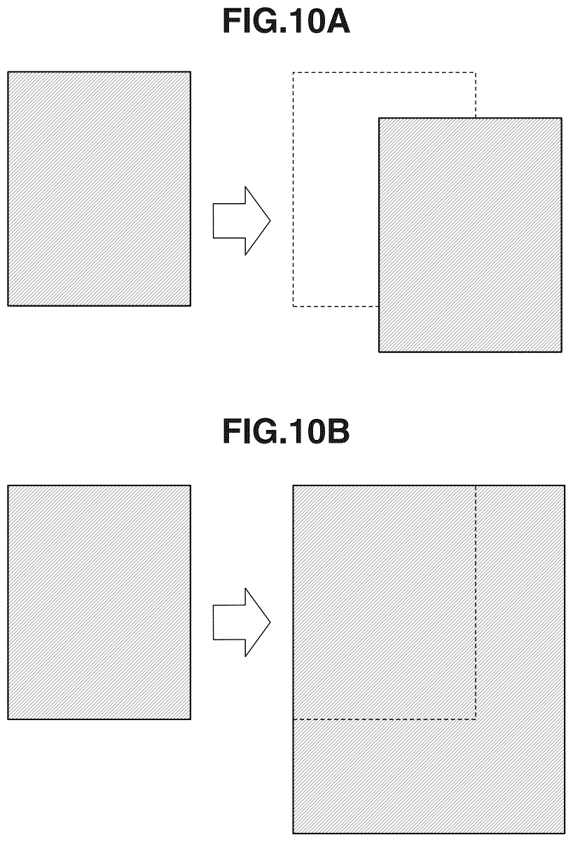

FIGS. 10A and 10B each illustrate an operation of editing an area obtained after the partial inspection area deletion is performed on the inspection area.

As illustrated in FIG. 10A, the inspection area obtained after the partial area deletion can be moved (location thereof can be changed) while the shape of the area is maintained. As illustrated in FIG. 10B, scaling up or scaling down of the area can be performed while the shape of the area is maintained. Accordingly, for example, even when the inspection area has the same shape but the sheet size thereof has been changed to a different size, the inspection area can be easily readjusted. If a deleted portion or a part of the deleted portion is to be designated again as the inspection area after the part of the inspection area is deleted and the inspection settings are stored, an additional setting for the inspection area need to be configured for the deleted part or a part of the deleted part.

With reference again to FIG. 7, after completion of updating the display in step S708, the processing returns to step S701, and the CPU 302 waits for a notification of a UI operation. Next, in step S709, the CPU 302 determines whether inspection area settings are completed. Specifically, the CPU 302 determines whether the inspection area settings are completed based on whether the OK button 613 illustrated in FIG. 6 is pressed. If the OK button 613 is pressed (YES in step S709), the CPU 302 determines that the inspection settings are completed, and then the processing proceeds to step S710. If the OK button 613 is not pressed (NO in step S709), the processing returns to step S701, and the CPU 302 waits for a notification of a UI operation.

In step S710, the CPU 302 stores the setting values set on the inspection settings screen in the RAM 303, and then terminates processing of the inspection settings. The inspection setting flow in step S403 has been described above.

According to the first exemplary embodiment, it is possible to provide an inspection system capable of improving the inspection setting operability.

In the present exemplary embodiment, a part of the inspection area 801 illustrated in FIG. 8C is deleted to obtain the inspection area 806, and then data on the inspection area 801 is held in, for example, the RAM 303 without deleting the data. When the button 602 is selected, by using the held data, it possible to restore the inspection area from the inspection area 806 to the inspection area 801. Data on the inspection area 806 is also held in, for example, the RAM 303. When the button 603 is selected after the inspection area is restored to the inspection area 801 by selecting the button 602, the inspection area can be changed from the inspection area 801 to the inspection area 806 using the held data.

In the first exemplary embodiment, a method for improving the inspection setting operability by deleting a part of the inspection area is described. In a second exemplary embodiment, a method for performing partial inspection area deletion when the inspection area is applied to pages other than a currently displayed page is described.

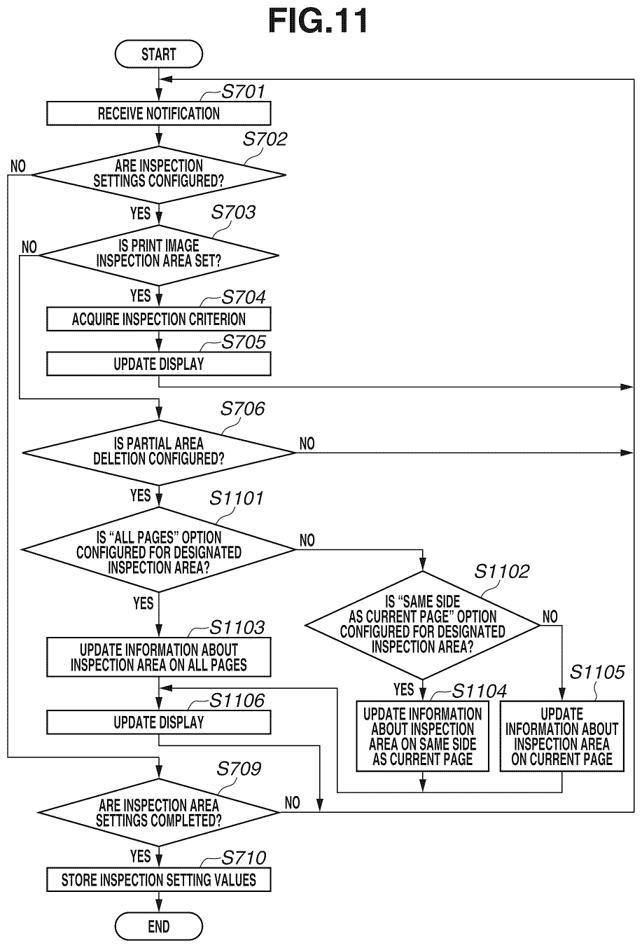

An inspection setting flow according to the second exemplary embodiment will be described with reference to a flowchart illustrated in FIG. 11. Processing in the flowchart illustrated in FIG. 11 is implemented by the CPU 302 of the inspection apparatus 110 loading a program code stored in the ROM 304 into the RAM 303 and reading out and executing the program code loaded into the RAM 303.

The processes of steps S701 to S706, S709, and S710 illustrated in FIG. 11 are similar to those illustrated in FIG. 7, and thus descriptions thereof are omitted.

In step S1101, the CPU 302 determines whether the inspection area for which the partial inspection area deletion is designated corresponds to the inspection area for which the “all pages” option is configured in the setting item 635 illustrated in FIG. 6. If the “all pages” option is configured for the designated inspection area (YES in step 1101), the processing proceeds to step S1103. If the “all pages” option is not configured for the designated inspection area (NO in step S1101), the processing proceeds to step S1102.

In step S1102, the CPU 302 determines whether the inspection area for which the partial inspection area deletion is designated corresponds to the inspection area for which the “same side as current page” option is configured in the setting item 635 illustrated in FIG. 6. If the “same side as current page” option is configured for the designated inspection area (YES in step S1102), the processing proceeds to step S1104. If the “same side as current page” option is not configured for the designated inspection area (NO in step S1102), the processing proceeds to step S1105.

In step S1103, the CPU 302 updates information about the inspection area on all pages by applying designation of the partial inspection area deletion to all pages. Updating of the information about the inspection area on all pages refers to updating of the information about the inspection area on the reference image on each of a plurality of pages, for example, in a case where the inspection job includes a plurality of pages. In other words, updating of the information about the inspection area on all pages refers to application of the partial inspection area deletion to the inspection area in the reference image on each page.

In step S1104, the CPU 302 updates information about the inspection area on the same side as the current page by applying designation of the partial inspection area deletion to the same side as the current page. Updating of the information about the inspection area on the same side as the current page refers to updating of the information about the inspection area in the reference image on a predetermined page and not updating the information on pages other than the predetermined page, for example, in a case where the inspection job includes a plurality of pages and the current page corresponds to the predetermined page. In other words, updating of the information about the inspection area on the same side as the current page refers to applying the partial inspection area deletion to the inspection area in the reference image on the predetermined page and not applying the partial inspection area deletion to the inspection area in the reference image on pages other than the predetermined page. In the present description, the term “one page” is synonymous with one surface image, which is a unit of imposition.

In step S1105, the CPU 302 updates the information about the inspection area on the current page by applying the designation of the partial inspection area deletion to the current page. In step S1106, the CPU 302 updates the display of the inspection area based on the information about the inspection area updated in steps S1103, S1104, and S1105.

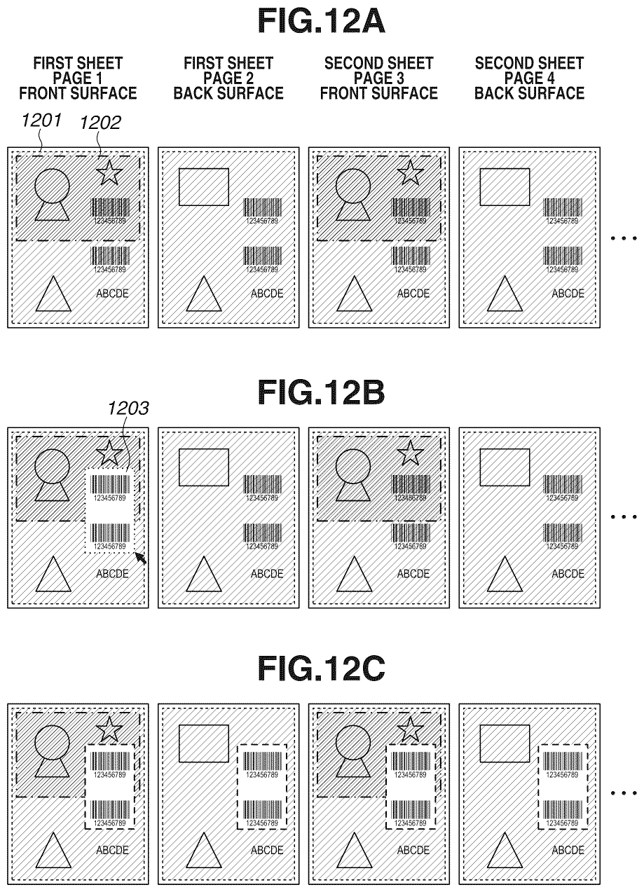

FIGS. 12A to 12C each illustrate an example of the partial inspection area deletion according to the second exemplary embodiment. In FIG. 12A, an inspection area 1201 and an inspection area 1202 are set. For the inspection area 1201, the “all pages” option is configured, and thus the inspection areas are located on all pages. For the inspection area 1202, the “same side as current page” option is configured, and thus the inspection areas are located on the front surface in FIG. 12A.

In FIG. 12B, an example of an area where the partial inspection area deletion is performed by pressing the partial area deletion button 608 illustrated in FIG. 6. In this case, a variable data portion corresponding to a barcode is deleted. A deleted portion 1203 is designated as a portion including both of the inspection area 1201 and the inspection area 1202.

FIG. 12C illustrates a case where the deleted portion 1203 illustrated in FIG. 12B is determined to be the inspection area for which the “all pages” option is configured as illustrated in step S1101, so that a part of the inspection area is deleted from all of the pages. Thus, the partial inspection area deletion is performed according to the setting of the scope of application of the inspection area to be subjected to the partial inspection area deletion, thereby making it possible to simplify the operation of performing partial inspection area deletion on each page.

The inspection setting flow in step S403 according to the second exemplary embodiment has been described above.

As described above, according to the second exemplary embodiment, it is possible to provide an inspection system capable of improving the inspection setting operability by performing partial inspection area deletion according to the setting of the scope of application of the inspection area.

While the present disclosure has been described with reference to various examples and exemplary embodiments, the spirit and scope of the present disclosure are not limited to the specific description in the specification.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151533, filed Sep. 3, 2024, which is hereby incorporated by reference herein in its entirety.

What is claimed is:

1. An inspection system comprising:
a reading unit configured to acquire a scanned image by reading a recording medium on which an image is formed; and
one or more controllers having one or more processors and one or more memories, the one or more controllers being configured to:
register a reference image;
perform an inspection on the scanned image by comparing the scanned image with the reference image;
set an inspection area to be inspected in the inspection; and
delete a part of the inspection area.

2. The inspection system according to claim 1, wherein the one or more controllers set, as an inspection target, another inspection area obtained by deleting a part of the inspection area from the inspection area based on deletion of the part of the inspection area.

3. The inspection system according to claim 2, wherein the one or more controllers further set an area on the reference image.

4. The inspection system according to claim 3, further comprising a display unit,
wherein the display unit displays the reference image and the inspection area in a case where the deletion of the part of the inspection area is not executed by the one or more controllers, and the display unit displays the reference image and the other inspection area in a case where the deletion of the part of the inspection area is executed by the one or more controllers.

5. The inspection system according to claim 4, wherein, in the case where the deletion of the part of the inspection area is not executed by the one or more controllers, the display unit highlights an area where the inspection area is set and does not highlight an area where the inspection area is not set, and in the case where the deletion of the part of the inspection area is executed by the one or more controllers, the display unit highlights an area where the other inspection area is set and does not highlight an area where the other inspection area is not set.

6. The inspection system according to claim 5, wherein highlighting is at least one of display using a color, display using a pattern, display by changing a transmittance, and display by changing a density.

7. The inspection system according to claim 3, wherein the one or more controllers are configured to perform a first setting and a second setting, setting an area on the reference image is performed on all pages in an inspection job in the first setting, and setting an area on the reference image is performed on a predetermined page in the inspection job in the second setting.

8. The inspection system according to claim 2, wherein the one or more controllers are configured to perform at least one of a process of scaling up or scaling down the other inspection area and a process of moving the other inspection area while maintaining a shape of the other inspection area.

9. The inspection system according to claim 2, wherein the one or more controllers are configured to restore a state where the inspection area is set as the inspection target after the other inspection area is set as the inspection target.

10. The inspection system according to claim 1, further comprising:
an image forming unit configured to form an image on a recording medium; and
a conveyance unit configured to convey the recording medium on which an image is formed by the image forming unit,
wherein the reading unit reads the image on the recording medium conveyed by the conveyance unit.

11. An inspection apparatus comprising:
a reading unit configured to acquire a scanned image by reading a recording medium on which an image is formed; and
one or more controllers having one or more processors and one or more memories, the one or more controllers being configured to:
register a reference image;
perform an inspection on the scanned image by comparing the scanned image with the reference image;
set an inspection area to be inspected in the inspection; and
delete a part of the inspection area.

12. The inspection apparatus according to claim 11, wherein the one or more controllers set, as an inspection target, another inspection area obtained by deleting a part of the inspection area from the inspection area based on deletion of the part of the inspection area.

13. The inspection apparatus according to claim 12, wherein the one or more controllers further set an area on the reference image.

14. The inspection apparatus according to claim 13, further comprising a display unit,
wherein the display unit displays the reference image and the inspection area in a case where the deletion of the part of the inspection area is not executed by the one or more controllers, and the display unit displays the reference image and the other inspection area in a case where the deletion of the part of the inspection area is executed by the one or more controllers.

15. The inspection apparatus according to claim 14, wherein, in the case where the deletion of the part of the inspection area is not executed by the one or more controllers, the display unit highlights an area where the inspection area is set and does not highlight an area where the inspection area is not set, and in the case where the deletion of the part of the inspection area is executed by the one or more controllers, the display unit highlights an area where the other inspection area is set and does not highlight an area where the other inspection area is not set.

16. The inspection apparatus according to claim 15, wherein highlighting is at least one of display using a color, display using a pattern, display by changing a transmittance, and display by changing a density.

17. The inspection apparatus according to claim 13, wherein the one or more controllers are configured to perform a first setting and a second setting, setting an area on the reference image is performed on all pages in an inspection job in the first setting, and setting an area on the reference image is performed on a predetermined page in the inspection job in the second setting.

18. The inspection apparatus according to claim 12, wherein the one or more controllers are configured to perform at least one of a process of scaling up or scaling down the other inspection area and a process of moving the other inspection area while maintaining a shape of the other inspection area.

19. The inspection apparatus according to claim 12, wherein the one or more controllers are configured to restore a state where the inspection area is set as the inspection target after the other inspection area is set as the inspection target.
